(19) United States
(12) Patent Application Publication
(10) Pub. No.: US 2021/0245510 A1
(43) Pub. Date: Aug. 12, 2021

(54) CONTACTLESS INKJET PRINT HEAD MAINTENANCE

(71) Applicants: Nano Dimension Technologies LTD., Nes Ziona (IL); THE IP LAW FIRM OF GUYLEVI, LLC, Wychoff, NJ (US)

(72) Inventors: Tal Rosenberg, Nir Israel (IL); Dan Kozlovski, Rehovot (IL); Dotan Sela, Kfar Bin Nun (IL)

(21) Appl. No.: 17/262,155

(22) PCT Filed: Jul. 19, 2019
(86) PCT No.: PCT/US2019/042540

§ 371 Date: Jan. 21, 2021

Related U.S. Application Data
(60) Provisional application No. 62/701,037, filed on Jul. 20, 2018.

(51) Int. Cl. B41J 2/165

(52) U.S. Cl. CPC B41J 2/1652

(57) ABSTRACT

The disclosure relates to systems and methods for contactless maintenance of inkjet print heads. Specifically, the disclosure relates to systems and methods for removing purged ink and other debris from one or more inkjet print heads without contacting the nozzle plate with mechanical means, such as wipes by selectably moving the print heads above discrete cleaning stations and unit operations involving vacuum and targeted washing.

### BACKGROUND

The disclosure is directed to devices, systems and methods for contactless maintenance of inkjet print heads. Specifically, the disclosure is directed to devices, systems and methods for removing purged ink and debris from inkjet print head and their surroundings without contacting the nozzle plate with mechanical means.

Inkjet printing heads require periodic cleaning of printing nozzles to remove buildup (solid sediments and debris) on the nozzles, remove air bubbles, remove pooled liquids and otherwise maintain printing quality. Cleaning the printing head is an inherent part of the inkjet printing process, for example in some industrial settings the printing head is cleaned as often as every two minutes. The cleaning frequency depends on the specific application for which the printing head is being used. Typically, cleaning can also be done by removing the print head to one side of the printer for easy access and cleaning the head either manually or using a wiper. These methods are time consuming and inefficient.

Typically, removing buildup without contact to the orifice (nozzle) plate can be done using vacuum where a vacuum ‘head’ is moved across the orifice plate. The vacuum head can be maneuvered sufficiently close to allow the vacuum induced suction to remove ink and residues from the orifice plate (interchangeable with nozzle plate). Because the vacuum head does not contact the orifice plate, efficiency of the orifice plate cleaning is low. Similarly, service stations (referring to a dedicated zone within the printer housing), have an elastomeric wiper that wipes the print head surface to remove ink residue, as well as other debris that has collected on the face of the orifice plate. Other service stations include auxiliary wiping members to clean areas of the print head and protective bracket adjacent to the ink ejecting nozzles.

Moreover, when the ink contains volatile components, the ink at a nozzle may lose those components, resulting, under certain circumstances, in the remaining ingredients of the ink forming a semi-solid skin at the nozzle. The semi-solid skin, or buildup of solid sediments, can interfere with the jetting of ink from the nozzles, reducing the print quality or even disabling jetting of ink from one or more nozzles. Likewise, using UV-curable ink may also cause build-up that may eventually block the nozzles, reducing print quality.

There is therefore a need for a system for cleaning orifice plates, with increased efficiency over conventional techniques, preventing sediment buildup, removing pooled liquids while simultaneously, not damaging the orifice plate itself.

### SUMMARY

Disclosed, in various embodiments, are systems and methods for removing purged ink and other debris from inkjet print head(s) and their surroundings, without contacting the nozzle plate of the print head(s) with mechanical means.

In an embodiment provided herein is a contactless cleaning system for at least one and a plurality of inkjet print heads comprising: a support bracket; a platform having a proximal end and a distal end, an apical surface and a basal surface, a portion of the basal surface coupled to the support bracket; a catch basin defined in the apical surface of the platform; for each of the at least one and plurality of inkjet print heads, an elongated bath defining a longitudinal axis, the elongated bath having length that is equal to or longer than the length of a nozzle plate of each of the inkjet's at least one and the plurality of print head; for each of the inkjet print heads, a suction duct disposed distally to the elongated bath, the suction duct having a tip protruding apically from the catch basin with an elongated slit defining a longitudinal axis transverse to the longitudinal axis of the elongated bath; for each of the plurality of inkjet print heads, an elongated washing port in communication with a pressurized liquid source and a vacuum source; and a vacuum blade having a length sized and configured to span a cross section of an area that needs cleaning due to wash liquid residue and other printing debris or condensation, the vacuum blade disposed distally to the washing port, being in communication with a vacuum source.

In another embodiment, provided herein is a method for contactless cleaning of at least one and a plurality of inkjet print heads, implementable in a system comprising: a support bracket; a platform having a proximal end and a distal end, an apical surface and a basal surface, a portion of the basal surface coupled to the support bracket; a catch basin defined in the apical surface of the platform; for each of the plurality of inkjet print heads, an elongated bath defining a longitudinal axis, the elongated bath having length that is equal to or longer than the length of a nozzle plate of each of the inkjet print head; for each of the at least one and plurality of inkjet print heads, a suction duct disposed distally to the elongated bath, the suction duct having a tip protruding apically from the catch basin with an elongated slit defining a longitudinal axis transverse to the longitudinal axis of the elongated bath; for each of the plurality of inkjet print heads, an elongated washing port in communication with a pressurized liquid source and a vacuum source; and a vacuum blade having a length sized and configured to span a cross section of an area that needs cleaning due to wash liquid residue and other printing debris or condensation, the vacuum blade disposed distally to the washing port, being in communication with the vacuum source, wherein each print head comprises: the nozzle plate with a grid of apertures along a longitudinal axis having a nozzle plate width transverse to the longitudinal axis of the nozzle plate; a guard plate with an elongated quadrilateral window sized and configured to expose the nozzle plate, the guard plate having guard plate width; and a dispensing means configured to dispense an ink, being in fluid communication with the ink reservoir, wherein the dispensing means is configured to dispense ink droplets through the nozzle plate the method comprising: at a first predetermined event, actuating the vacuum source; advancing the plurality of print head along the longitudinal axis of the apertures grid in the nozzle plate in a proximal distance above the vacuum blade thereby removing excess ink from the nozzle plates area that needs cleaning; following clearing of a distal end of the guard plate, purging the at least one and the plurality of print heads into at least one of the elongated bath and catch basin; and advancing the at least one and plurality of print head along the longitudinal axis of the apertures grid in the nozzle plate in distal direction above the suction duct, thereby removing purged ink and cleaning the plurality of nozzle plates and guard plates.

These and other features of the methods, and systems for removing purged ink and other debris from inkjet print head without contacting the nozzle plate with mechanical means, will become apparent from the following detailed description when read in conjunction with the figures and examples, which are exemplary, not limiting.

### BRIEF DESCRIPTION OF THE FIGURES

For a better understanding of the cleaning systems and methods disclosed for removing purged ink and other debris from inkjet print head without contacting the nozzle plate with mechanical means, with regard to the embodiments thereof, reference is made to the accompanying examples and figures, in which:

FIG. 1 illustrates a perspective view of the cleaning platform;

FIG. 2A, illustrates a X-Z cross section A-A of the embodiment illustrated in FIG. 1, with Y-Z cross section of the wash port only—illustrated in FIG. 2B;

FIG. 3, illustrates another embodiment of the elongated bath protruding from the catch basin;

FIG. 4, illustrates the initiation of washing cycle using the elongated bath of FIG. 3;

FIG. 5A, illustrates a first embodiment of pressurized washing of the nozzle plate, with a flooding and inverse purge of wash liquid into the nozzle plate illustrated in FIG. 5B;

FIG. 6A, illustrates purging of the print head into the elongated bath illustrated in FIG. 3, with ink “spitting” of the print head into the elongated bath of FIG. 3 illustrated in FIG. 6B;

FIG. 7, illustrates drying or conditioning the nozzle plate, via the suction duct;

FIG. 8, illustrates the cover cap positioned above the elongated bath illustrated in FIG. 3;

FIG. 9A, illustrates an embodiment of a cleaning station for a single print head, with a cleaning station for two or more (n) printing heads illustrated in FIG. 9B, and a cleaning station for any number of printing heads using a X-Y maneuverable single cleaning station illustrated n FIG. 9C;

FIG. 10, illustrates an embodiment of the sequence of operations for the contactless cleaning;

FIG. 11A illustrates a schematic illustration of a front elevation view of the washing port in operation with a bottom perspective view of the print head illustrated in FIG. 11B;

FIG. 12 illustrates the spray nozzle spraying at close proximity (wash port). The black arrow directed down is the air vacuum which keeps the liquid spray from exiting via the space between the nozzle and the print head and is a side elevation view of FIG. 11A;

FIG. 13, illustrates a schematic of a side view of the print head above the elongated bath and suction duct;

FIG. 14, illustrates a schematic cross section X-Z view of an embodiment of the suction duct in enlarged section B of FIG. 2; and

FIG. 15, is a schematic of the system's architecture showing interrelations among the systems components for a single print head without ink or washing fluid recycling option;

FIG. 16, is a schematic of the system's architecture showing interrelations among the systems components for a single print head with ink and/or washing fluid recycling option;

FIG. 17, is a schematic of the system's architecture showing interrelations among the systems components for a plurality (2 or more) print heads without ink or washing fluid recycling option;

FIG. 18, is a schematic of the system's architecture showing interrelations among the systems components for a plurality (2 or more) print heads with ink and/or washing fluid recycling option; and

FIG. 19A, is an embodiment of the cleaning platform with a combination of the elongated baths of FIGS. 1 and 3, with a different washing port configuration, with yet another embodiment illustrated in FIG. 19B.

### DETAILED DESCRIPTION

Provided herein are embodiments of systems and methods for removing purged ink and other debris from inkjet print head without contacting the nozzle plate with mechanical means.

A more complete understanding of the components, processes, assemblies, and devices disclosed herein can be obtained by reference to the accompanying drawings. These figures (also referred to herein as “FIG.”) are merely schematic representations (e.g., illustrations) based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

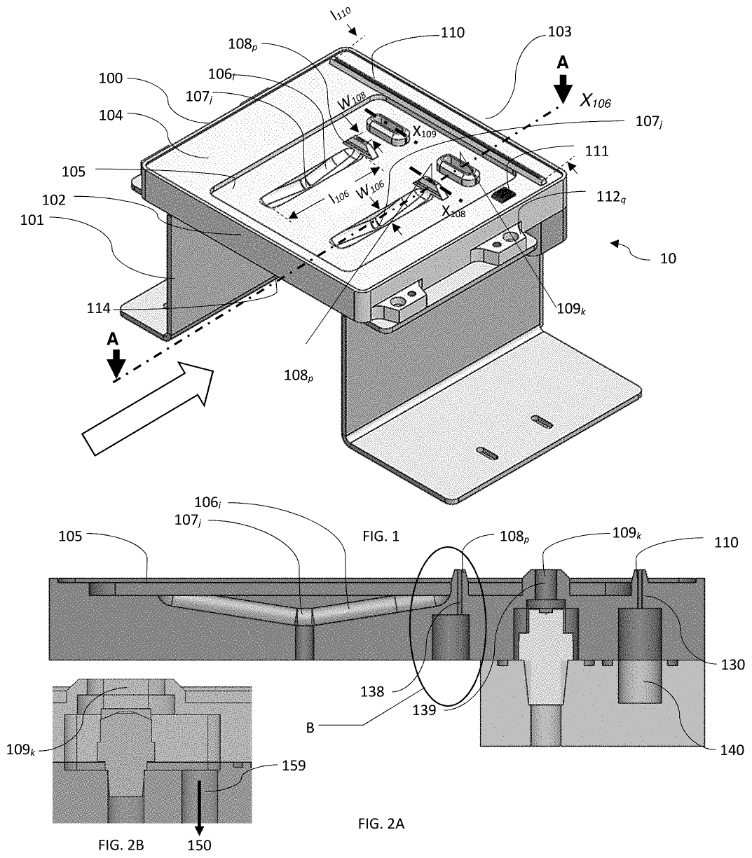

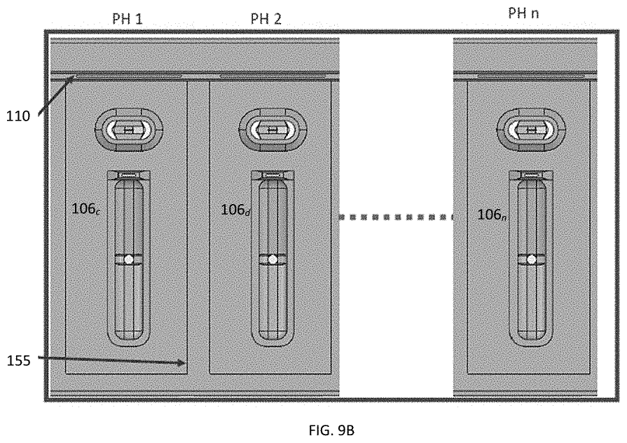

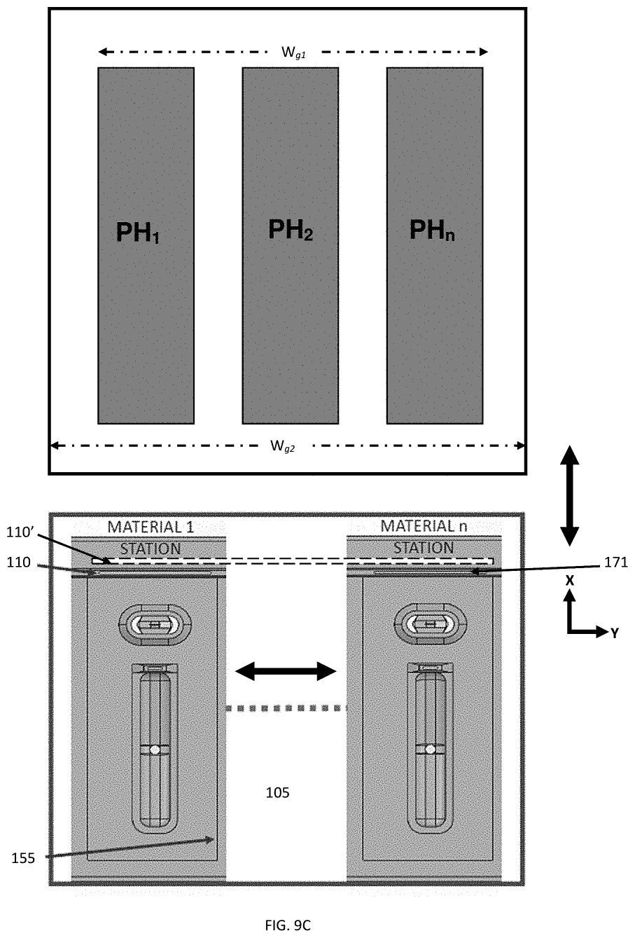

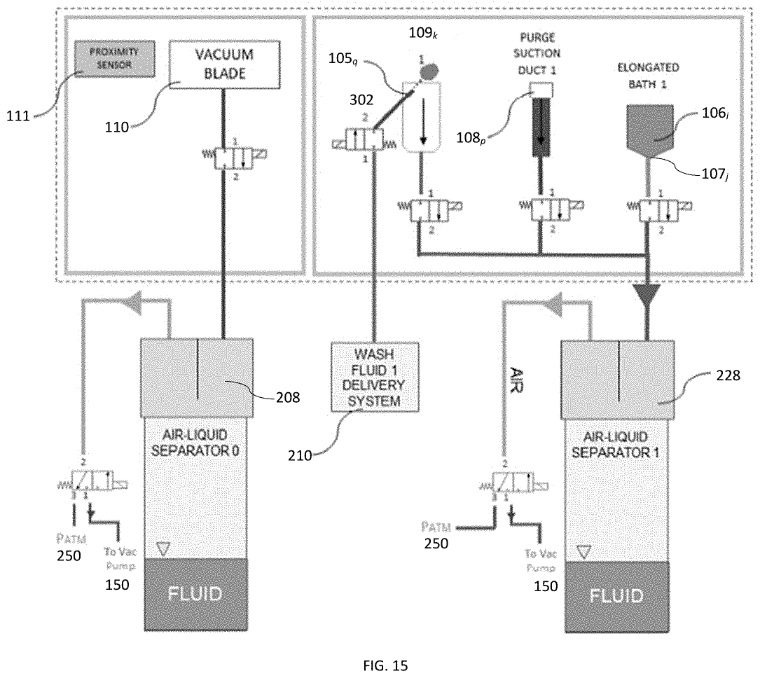

Turning to FIGS. 1-14 illustrating a contactless inkjet print head cleaning station 10 comprising: support bracket 101 with platform 100 (additional embodiments are shown in FIGS. 19A and 19B) having proximal end 102 and distal end 103, apical surface 104 and a basal surface 114, whereby portion of basal surface 114 is operably coupled to support bracket 101, for example, using coupling/leveling tabs 112_{q} enabling calibration/adjustment of the plane of suction nozzles (108 X 2, 109 X 2, 110) to the exact distance from print head 500 nozzle plate(s) 501 Also shown in FIGS. 1, 9A-9C, is catch basin 105 defined in apical surface 104 of platform 100. Each of the plurality of inkjet print heads (see e.g., FIGS. 11A, 11B, 9C) there is elongated bath 106ᵢ defining longitudinal axis X₁₀₆, elongated bath 106ᵢ having length 1106 that is equal to or longer than the length of nozzle plate 501, 1501 (interchangeable with orifice plate see e.g., FIG. 4A) of each of the inkjet print heads 500 (see e.g., FIG. 5). For each of the plurality of inkjet print heads 500, suction duct is disposed distally to the elongated bath, suction duct having tip 108ₚ protruding apically from catch basin 105 with an elongated slit defining a longitudinal axis X₁₀₈ transverse to the longitudinal axis X₁₀₆ of elongated bath 106ᵢ. In addition, for each of the plurality of inkjet print heads 500, elongated washing port 109k in communication with a pressurized liquid source (see e.g., 210, FIG. 15) In certain embodiments, washing port 109k further comprises vacuum conduit 159 (see e.g., FIG. 2B), sized and configured to contain the washing to the designated area and removes any resulting excesses. Also illustrated in FIGS. 1, and 9A-9C is vacuum blade 110 having length l₁₁₀ spanning at least one side of catch basin 105, vacuum blade 110 disposed distally to washing port 109k, being in communication with vacuum source 150, see e.g., FIGS. 15-18). Moreover, in another embodiment, vacuum blade 110 is configured to span at least the nozzle plate and up to the width of protective plate 505 of all printing heads 500, including between and around print heads 500. Likewise, vacuum blade 110 can be extended anywhere the print head 500 group are desired to wipe from debris due to printing condensate, spray, pooling and the like.

For example, as seen in FIG. 9C, catch basin 105 can accommodate the full length l₁₁₀ of vacuum blade 110 and can be configured to be drained to a waste container (see e.g., 208 FIG. 15). As seen in FIGS. 9A-9C, and 19A-19B vacuum blade can have slits 171 configured to provide fluid communication to vacuumed fluids across a single print head, between adjacent print heads and at the periphery—wherever it is desired to clean liquids such as pooled liquids, debris and ink.

Also shown, in FIG. 1, is sensor 111 located on apical surface 104. Sensor 111 can be configured to sense the location of proximal end 503 of print head 500 and/or distal end 504 of print head 500 and/or print head 500 support bracket 505 or designated edge (see e.g., FIG. 11A), or designated edge thereof, to actuate or terminate processes for cleaning or steps in the methods disclosed. Additional sensor 111′ (not shown) can be positioned on platform 100, opposite sensor 111, and can each be functionally coupled to a different print head 500, platform support bracket 101 and/or designated edge thereof, and be configured to actuate the various unit operations. Furthermore, additional sensors can be added for safety or redundancy. In another embodiment, some or all of the sensors can be replaced by, or used in parallel with axis' (e.g., X₅₀₅) encoders for location verification and validation.

Nozzle (orifice) plate 501, can be located on the printing side (lower, or basal surface) of printing head 500 (see also FIG. 11B), providing access for the nozzles to print. Purged ink 600 from each nozzle can exit the orifice grid. Purging, in other words, forcing ink out of the nozzles by pressure, may, under certain circumstances, cause ink drops 600 to be left hanging by adherence to the nozzle plate. Similar circumstances (in other words, ink drops 600 are left hanging by adherence to the nozzle plate) can be caused by a tickling process, referring to the formation of a pulse waveform configured to fill the orifice(s) without actually ejecting the ink drops, yet, due to surface phenomena where ink partially blocking the orifice(s), and surface tension, some ink will be expelled nonetheless.

The adhered can then be vacuumed by suction nozzle 108ₚ; and may (or may not) be recycled back into the ink recycling system. Purging (or tickling) is done for example, to refresh the ink in the print head ducts and nozzles. During at least one of: periodic cleaning after purging, and tickling, the orifice surface can be cleaned to remove buildup, purged liquid, and enable proper jetting of the printing ink from the nozzles (via the orifices). In order to preserve the smoothness and high interfacial tension between the printing side and the jetted ink (non-wetting, or drop forming characteristic) and the orifice surface, cleaning must be affected.

The term “fluid communication” or “liquid communication” refers to any area, a structure, or communication that allows for fluid communication between at least two fluid retaining regions, for example, a tube, duct, conduit or the like connecting two regions. One or more fluid communication can be configured or adapted to provide for example, vacuum driven flow, electrokinetic driven flow, control the rate and timing of fluid flow by varying the dimensions of the fluid communication passageway, rate of circulation or a combination comprising one or more of the foregoing. Alternatively, and in another embodiment, the term “in communication” can also refer to gaseous communication, i.e. that gas may be transferred from one volume to another volume since these volumes are in communication. This term does not exclude the presence of a gas shutter or valve between the volumes that may be used to interrupt the gas communication between the volumes.

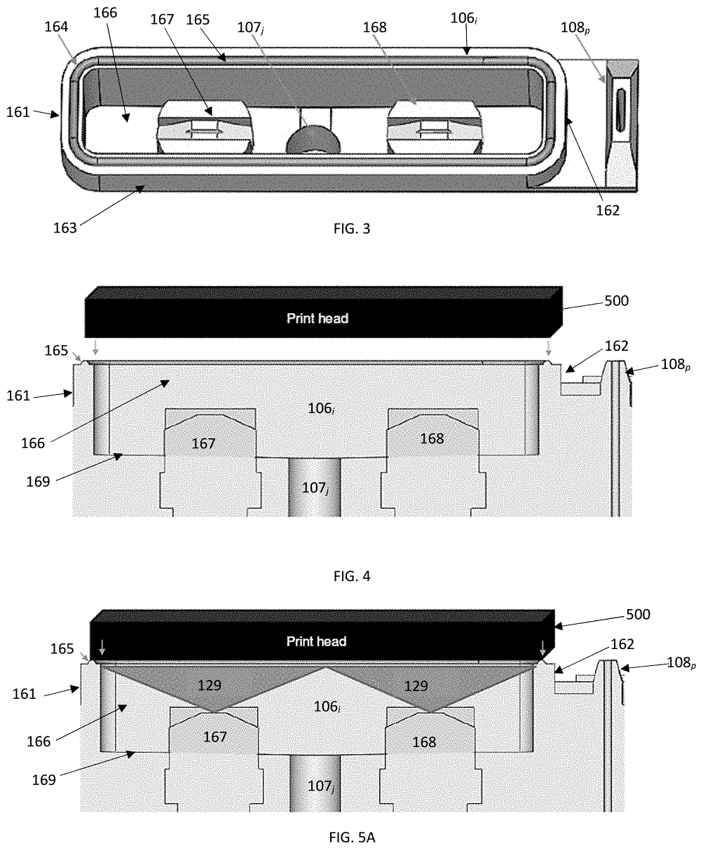

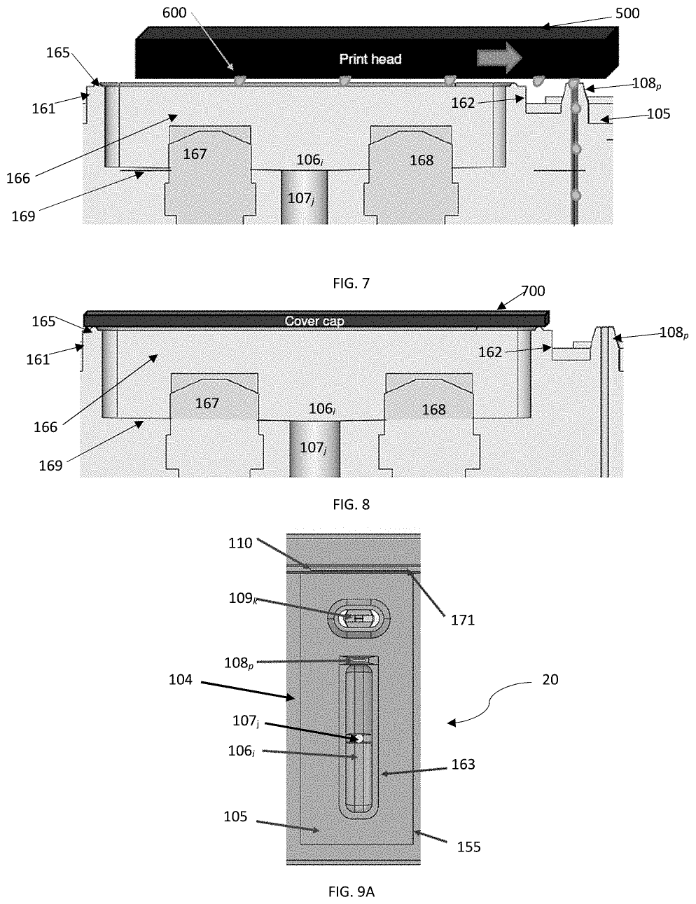

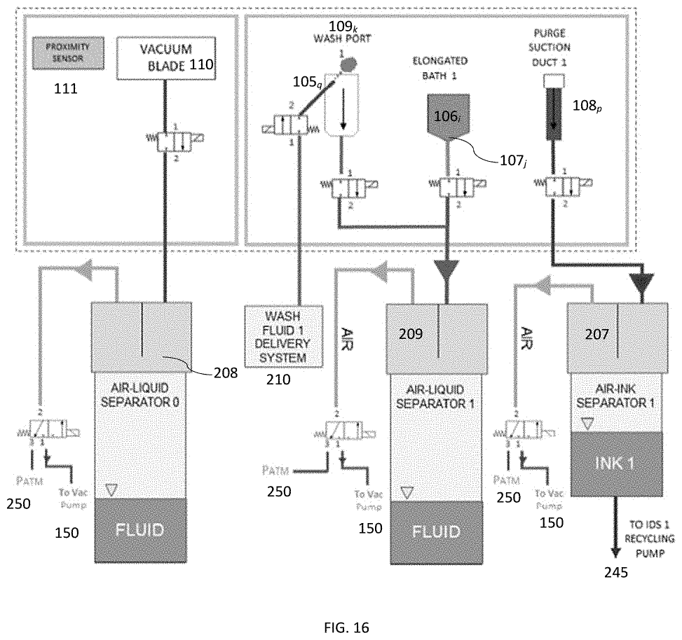

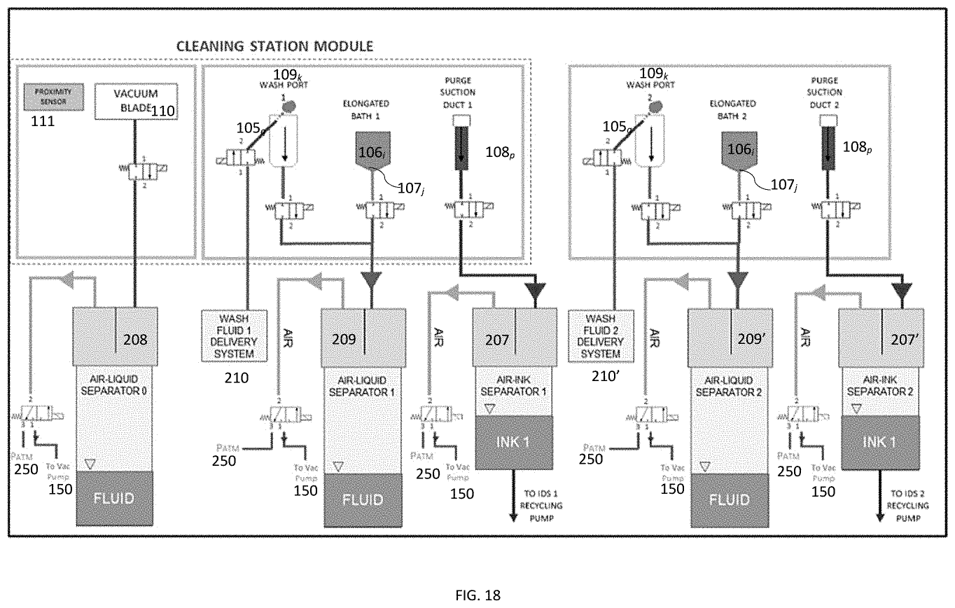

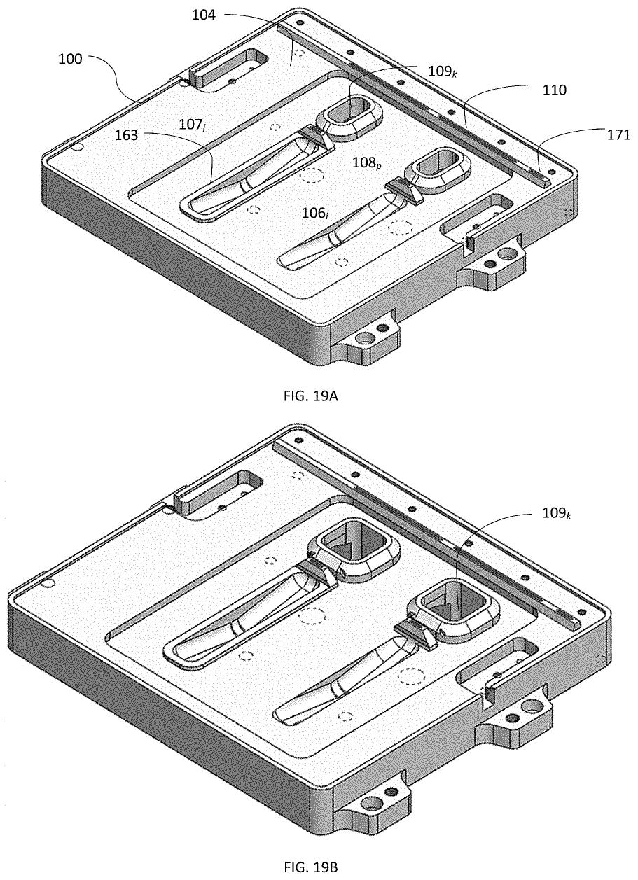

Additional embodiments of elongated bath 106i are illustrated in FIGS. 3-8, where elongated bath 106i has a proximal end 161 and distal end 162, with peripheral wall 163 protruding above catch basin 105 (see e.g., FIG. 7), wherein wall 163 defining lip 164 with a channel therein (not shown), configured to accommodate and engage a gasket (e.g., O-ring) sized and configured to abut guard plate 505 of print head 500, thus sealing elongated bath. Also shown is internal cavity 166 and elongated bath floor 169. Washing ports 167, 168 can, for example be the same as wash port 109k, including vacuum pipe 159 (see e.g., FIG. 2B); and have the same fluid communication to recycling modules as illustrated in FIGS. 16 and 18, or to waste tank 228, as illustrated in FIG. 15.

Accordingly and in an embodiment, as illustrated in FIG. 4-5B, in arriving to the cleaning module, print head can be maneuvered and either lowered to abut gasket 165, or cleaning stage 20 (see e.g., FIG. 9A) can be maneuvered such that gasket 165 abuts guard plate 505, creating a sealed tub. Once sealed, using pressurized washing liquid 129, guard plate 505 and nozzle plate 501 can be sprayed using washing ports 167, 168 (see e.g., FIG. 5A). Additionally or alternatively, elongated bath 106i can be filled (see e.g., FIG. 5B), such that washing liquid 129 is forced through nozzle plate 501 into print head 500, then expelled again once elongated bath 106ᵢ is drained through drain 107_{g}.

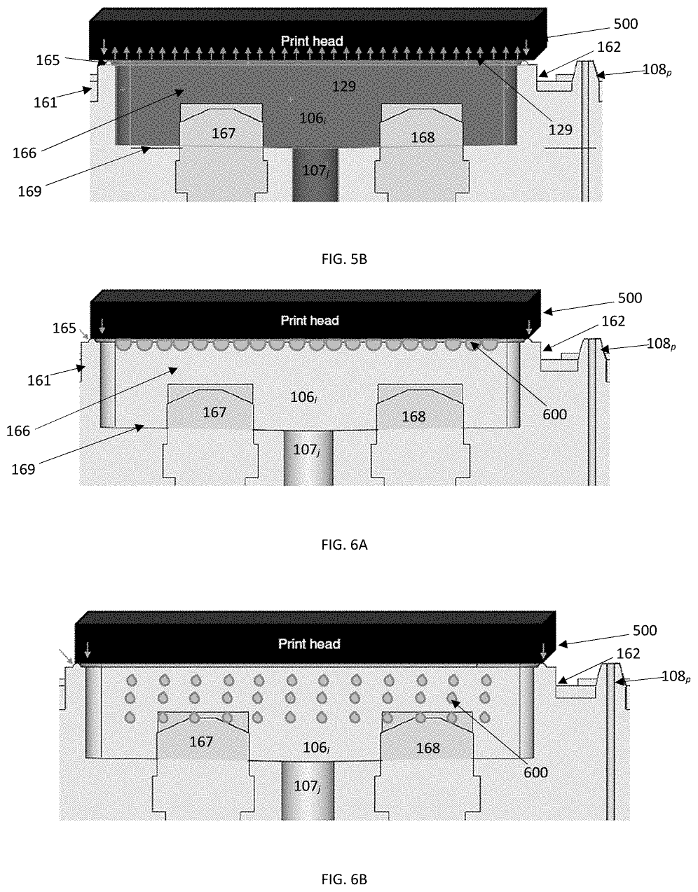

For example, the area desired to be washed, such as at-least the nozzle area, can be enclosed fully and potentially hermetically in the tub. In this embodiment the tub serves as a capping station (see e.g., FIGS. 5A, 5B) and/or purge bath (See e.g., FIGS. 6A, 6B) as well as wash port 109k, and may allow other functions such as vacuum purge (see e.g., FIG. 6A), whereby the force for the nozzle purge comes from a controlled vacuum source 150 (see e.g., FIG. 15) in the wash port, and/or inverse nozzle purge (see e.g., FIG. 5B), whereby washing fluid 129 is controllably forced through print head 500 nozzle plate 501 into print head 500, for example for clearing blockages. Other various combinations of the methods described including the controlled draining of the fluids and gasses from the wash port during or after said methods are possible as illustrated in FIGS. 6A, 6B.

In another embodiment, as illustrated in FIGS. 7, 8 elongated bath 106ᵢ opening may be covered by cover 700 closed by an actuating mechanism (not shown), which, when closed, does not allow spray washing liquid 129 to exit the elongated bath 106ᵢ. Cover 700 can further add protection, contained self-washing functionality as well as means for system diagnosis without the need for external cover at a specified distance such as with print head 500 when washing.

Turning now to FIGS. 9A-9C, illustrating washing stage 20, which can be a single module as illustrated in FIG. 9A, a part of a plurality of static washing modules as illustrated in FIG. 9B, or as part of a maneuverable (in other words, motorized and mobile) stage on X and/or Y and/or Z axis to serve a plurality of print heads (see e.g., FIG. 9C)

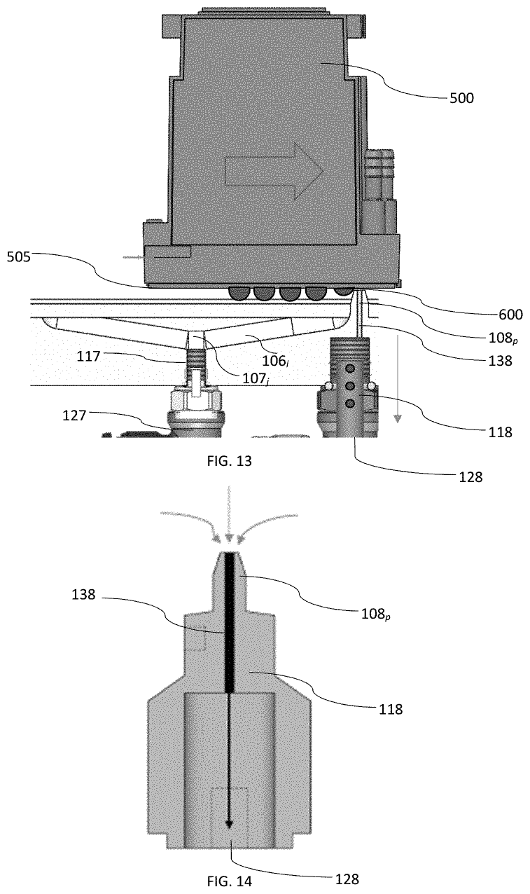

An embodiment of inkjet print head 500 having proximal end 503 and distal end 504, is illustrated in FIGS. 11A-13 and can comprise: nozzle plate 501 (see e.g., FIG. 11B) with a grid of apertures along a longitudinal axis X₅₀₁ having a nozzle plate width W₅₀₁ transverse to longitudinal axis X₅₀₁ of nozzle (or aperture) plate 501. Print heads 500 can also have guard plate 505 with elongated quadrilateral window 506 sized and configured to expose nozzle plate 501, the guard plate having guard plate width W₅₀₅ and dispensing means configured to dispense ink 600 (see e.g., FIG. 13), being in fluid communication with the ink reservoir (not shown), wherein the dispensing means (e.g., pump, piezo-electric pulse, membrane and the like) is configured to dispense ink 600 droplets through nozzle plate 501. The dispensing means can be, for example an apparatus for dispensing small quantities of liquid including micro-valves, piezoelectric dispensers, continuous-jet print-heads, boiling (bubble-jet) dispensers, and other means affecting the temperature and properties of the fluid flowing through the dispenser.

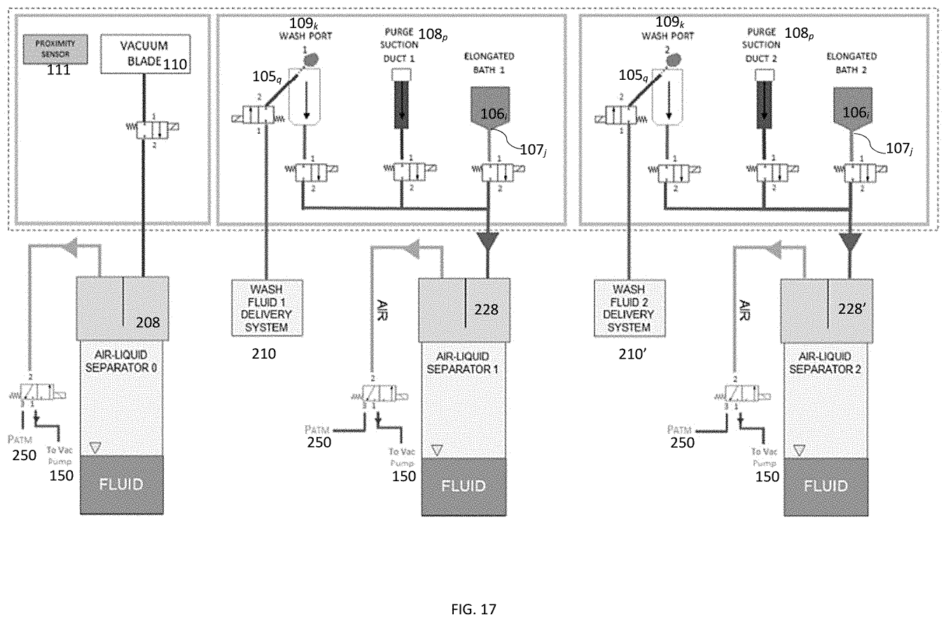

Turning now to FIGS. 1 and 2A-2B, where each of elongated baths 106 further comprise drain 107ⱼ in fluid communication with first receptacle 228 (see e.g., FIG. 15, 17). As illustrated, elongated bath 106ᵢ is slanted toward drain 107ⱼ, with elongated bath width W₁₀₆ that is equal to or wider than width W₅₀₁ of nozzle plate 501. Similarly and as illustrated in FIGS. 2A and 12-14, each suction duct having tip 108ₚ protruding apically from catch basin 105 can be in fluid communication with vacuum source 150 (see e.g., FIGS. 15-18), through dedicated vessel, 228 (see e.g., FIGS. 15, 17), configured to capture and collect ink 600 adsorbed onto at least one of nozzle plate 501 and guard plate 505 (see e.g., FIG. 13) of print head 500. Tip 108ₚ width W₁₀₈ of elongated slit in tip 108ₚ of the suction duct sized to be equal to or wider than width W₅₀₁ of the nozzle plate 501. However, in certain embodiments, width W₁₀₈ of elongated slit in tip 108ₚ of the suction duct sized to be equal to width W₅₀₁ of the nozzle plate 501 exactly. As illustrated in FIGS. 19A, 19B, Tip 108ₚ of the suction duct can have other shapes and sizes and may not necessarily be elongated, yet can still be sized to be equal to or wider than width W₅₀₁ of the nozzle plate 501.

Returning now to FIGS. 1, 2, 5A, 11B and 19A and 19B, elongated (in certain embodiment, or other aperture shapes) washing port protrudes apically from catch basin 105 floor, protrusion 109k (see e.g., FIGS. 11B, 19A, 19B) defining an elongated opening with axis X₁₀₉ transverse (or parallel, see e.g., FIG. 19A) to longitudinal axis of the elongated bath X₁₀₆ and width W₁₀₉ that is equal to or larger than width W₅₀₅ of the print head's guard plate (see e.g., FIG. 11B). In addition, elongated washing port further comprises a liquid ejection nozzle 119 (see e.g., FIG. 11A), sized and configured to eject a fan-shaped washing liquid 129 at an angle θ of between about 0° and about 180° (see e.g., FIGS. 5A, 11A), for example, between 15° and 65°. Furthermore, width W₁₂₉ of washing liquid fan 129 is configured and sized to be equal to or larger than nozzle plate 501 width W₅₀₁ yet smaller than width W₅₀₅ of guard plate 505 of print head 500, thus being configured to wash the whole basal surface of print head 500. The washing liquid is pressurized for example, to at least about one (1) atmosphere, or between about 0.1 Atm. and about 150 Atm., or between about 0.1 Atm. and 6.0 Atm. In other embodiment, and as illustrated in FIG. 5A, the fan-shaped spray may be configured to cover the whole underside of print head 500 and even overlap when two (or more) washing ports 167, 168 are used, with the fan-shaped spray being in parallel with the longitudinal axis X₅₀₁ of nozzle plate 501. Although the disclosure refers to fan-shaped spray, depending on the desired use, other spray shapes are contemplated, for example full cone spray, hollow cone spray, full jet blast, hollow circular spray, flat fan and their combination. For example, in the embodiment illustrated in FIGS. 3-6B, it is contemplated that the spray shape of cleaning liquid 129 used in wash ports 167, 168, can be the same or different, for example wash port 167 will spray a hollow cone, while washing port 168 will spray a flat fan. Moreover, the washing fluid expelled from each washing port 167, 168 can be different or the same.

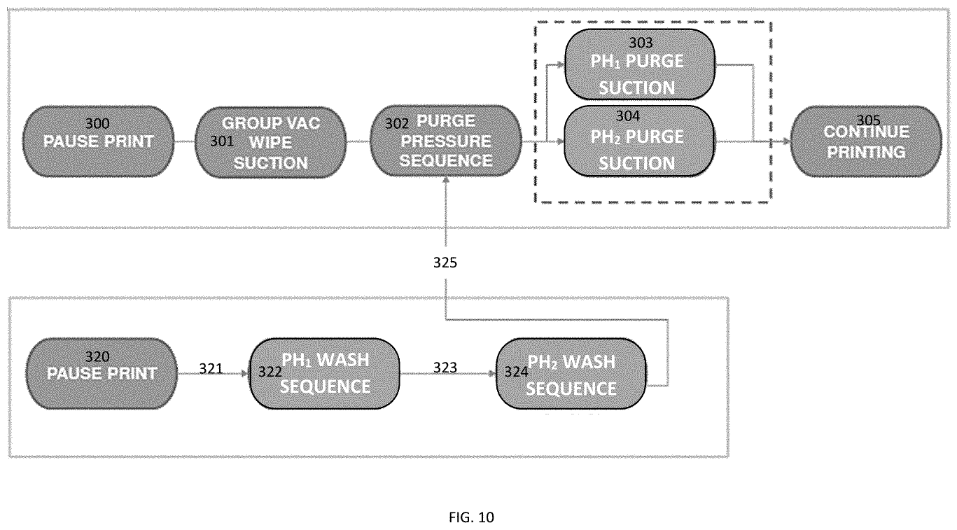

FIGS. 15 and 17 illustrate an embodiment of the washing module directed to a single (FIG. 15) or a plurality (FIG. 17) print head(s), without recycling option. As illustrated, air/liquid separators 208 (illustrated in fluid communication, in other words, hydraulically coupled with and to vacuum blade 110), and 228, can be the same or discrete units and the determination on keeping the separators the same or different can be based on the printed materials (inks) and the needs of the user. As illustrated, vacuum blade 110 can be used to dry or otherwise wipe liquids and other debris from the area sought to be cleaned (see e.g., FIG. 10) following purging, either to catch basin 105 or to elongated bath 106i as illustrated in FIGS. 5A, 5B. Similarly, catch basin 105, suction duct 108ₚ, and wash port 109k can be in fluid communication with air/liquid separator 228, while wash port 109k, being in fluid communication with wash liquid 129 delivery system 210. As illustrated in FIG. 17, the architecture can be duplicated for two or more print heads both in terms of stage 20 (see e.g., FIG. 9A, 9B), as well as separators 228, 228′, while air/liquid separators 208 being in fluid communication with vacuum blade 110 can be single reservoir, or as illustrated in FIGS. 9B, and 19A, each slit 171 in vacuum blade 110, may be directed to different reservoirs (separators) e.g., 208′, 208″ and the like.

Conversely, FIGS. 16 and 18, illustrate an embodiment of the washing module directed to a single (FIG. 16) or a plurality (FIG. 18) print head(s), with recycling option. As illustrated, air/liquid separator 208 in fluid communication with vacuum blade 110, while wash port 109k elongated bath 106ᵢ, are in fluid communication with dedicated separator 209 with suction duct 108ₚ in fluid communication with dedicated separator 207. Each separator can be in further communication with a vacuum source 150 and a compressor 250 and allowing the collected liquid to further undergo recycling. Similar to the non-recycling embodiments, vacuum blade 110 can be used to dry or otherwise wipe liquids and other debris from the area sought to be cleaned (see e.g., FIG. 10) following purging, either to catch basin 105 or to elongated bath 106ᵢ as illustrated in FIGS. 5A, 5B. Similarly, catch basin 105, suction duct 108ₚ, can be adapted to collect purged ink(s) and be in fluid communication with air/liquid separator 207, where collected inks can be recycled and returned to print heads 500. As illustrated in FIG. 18, the architecture can be duplicated for two or more print heads both in terms of stage 20 (see e.g., FIG. 9A, 9B). Under certain circumstances, depending on the ink used in each print head, washing liquid 129 used to wash nozzle plate 501 and guard plate 505 used for one print head 500 (e.g., PH₁), will be different than washing liquid 129′ used for another print head 500 (e.g., PH₂), or be changed sequentially on the same print head. Moreover, in the embodiment illustrated in FIGS. 3-6B, it is contemplated that the washing liquid 129 expelled from wash port 167 will be the same or different than washing liquid 129′ expelled from washing port 168. Selection of washing liquid 129, can be dependent on, for example, the type of ink used, the desired cleaning, the stage of cleaning, whether debris is present rather than pooled ink or purged ink, whether there are blockages in the nozzle plate, their combination and the like. It stands to reason, that recycling and reclamation of different washing liquids, each associated with a different print head can also be done using dedicated air/liquid separators 207, 207′ (see e.g., FIG. 18).

In other words, the methods disclosed herein provide for utilizing a sequence of different washing solutions through the same washing port 109k on the same print head 500 to clean nozzle plate 501 and its surrounding (in other words, between adjacent print heads 500 e.g. PH₁, PH₂, and PH₃ in FIG. 9C, and around the whole group of print heads), can be carried out for circumstances where the material and/or the residue form the first cleaning solution cannot be removed by the single solution washing step. Consequently, a sequence of solutions can be used in such a way that the second (or third or more) solution is formulated and configured to remove the residue, ink or debris left-over form the previous step, and if necessary additional washing steps can be applied. In another embodiment, the last step comprises a fast drying solution such as, for example, isopropyl alcohol, acetone (if possible) or deionized (DI) water, each utilized so long as it is a compatible with printer head 500 nozzle's plate 501 material.

In an embodiment, the methods described herein are implemented using the systems described. Accordingly, provided herein is a method for contactless cleaning of a plurality of inkjet print heads 500, implementable in a system comprising: support bracket 101; platform 100 having a proximal end 102 and distal end 103, apical surface 104 and basal surface 114, a portion of which is coupled to support bracket 101. Platform 100 also comprises catch basin 105 defined in apical surface 104 of platform 100. For each of plurality of inkjet print heads 500, elongated bath 106ᵢ exists, defining longitudinal axis X₁₀₆, elongated bath 106ᵢ having length 1106 that is sized and configured to be equal to or longer than length l₅₀₁ of nozzle plate 501 of each of inkjet print head 500. In addition, for each of plurality of inkjet print heads 500, a suction duct is disposed distally to elongated bath 106ᵢ, suction duct having tip 108ₚ protruding apically to catch basin 105 with an elongated slit defining longitudinal axis X₁₀₈ transverse to longitudinal axis X₁₀₆ of elongated bath 106ᵢ. Also, for each of plurality of inkjet print heads 500, there is an elongated washing port 109k in communication with a pressurized liquid source and a vacuum source 159 configured to contain the washing spray. Although shown as an elongated opening with a major axis X₁₀₉ transverse to longitudinal axis X₅₀₁, other aperture shapes are contemplated.

Further, platform 100 comprises vacuum blade 110 having length l₁₁₀ spanning at least catch basin 105 side, vacuum blade 110 disposed distally to washing port 109k, being in communication with a vacuum source, wherein each inkjet print head 500 comprises: nozzle plate 501 with a grid of apertures along longitudinal axis X₅₀₁ having nozzle plate width W₅₀₁ transverse to longitudinal axis X₅₀₁ of nozzle plate 501 with guard plate 505 with elongated quadrilateral window 506 sized and configured to expose nozzle plate 501, guard plate505 having guard plate width W₅₀₅; and a dispensing means configured to dispense ink 600, being in fluid communication with ink reservoir (not shown), wherein the dispensing means is configured to dispense ink 600 droplets through nozzle plate 501, the method comprising: at a first predetermined event (e.g., purging), depending on the type of printing, the ink and the printing conditions, (optionally automatically) actuating vacuum source 150 (see e.g., FIGS. 15-18). In an embodiment, using the first predetermined time event to reduce the number of times and the time length for purging processes.

A predetermined event can be, for example a set time lapse period, number of prints generated, time length of a single print process, amount of ink used in over one or several printing process(es), residue build-up detected by user or sensors (e.g., cameras configured to inspect the orifice plate(s)). For example, at designated times during a print job, such as when alternating printing between print heads and/or printing materials, before starting to print, upon detecting deterioration of printing by sensors (camera) on a print output, before, after, and/or as part of a series of other actions such as print head docking, print head capping, tickling, replacement of print head and/or ink or other fluid circulated through the print head such as cleaning solution.

At the predetermined event simultaneously advancing all the plurality of print head 500 along their longitudinal axis X₅₀₁ of apertures grid in nozzle plate 501 (see e.g., FIG. 11B) in a proximal direction (in other words, from distal end 103 toward proximal end 102) above vacuum blade 110 thereby removing excess ink and other loose debris and/or pooled liquids from each nozzle plate 501, as well as guard plate 505, as well as other areas between and around print head(s) 500. Following clearing of distal end 503 of guard plate 505 (detected in an embodiment by sensor 111, purging print heads 500 into at least one of elongated bath 106ᵢ and catch basin 105; and advancing plurality of print head 500 along longitudinal axis X₅₀₁ of apertures grid in nozzle plate 501 in distal direction above the suction duct 108ₚ thereby removing purged ink and in a contactless manner, cleaning plurality of nozzle plates 501 and guard plates 505.

In an embodiment, maintenance procedures utilizing the contactless cleaners described herein, can typically include purging ink through apertures of the print head, which can also be referred to as “burping”. In order to purge ink from print head 500 of e.g., FIGS. 6A, 6B, and 13 a purge pressure may be applied to ink in an on-board reservoir (not shown) using a pressure source (e.g., air pump, or compressed air tank) through an opening, or vent, operably coupled to print head 500. In an embodiment, the term “purge pressure” refers to the pressure of air (or other gas) applied to ink 600 in an on-board reservoir that is configured to urge ink from the reservoir through the inkjet ejectors and be released from the apertures in nozzle plate 501.

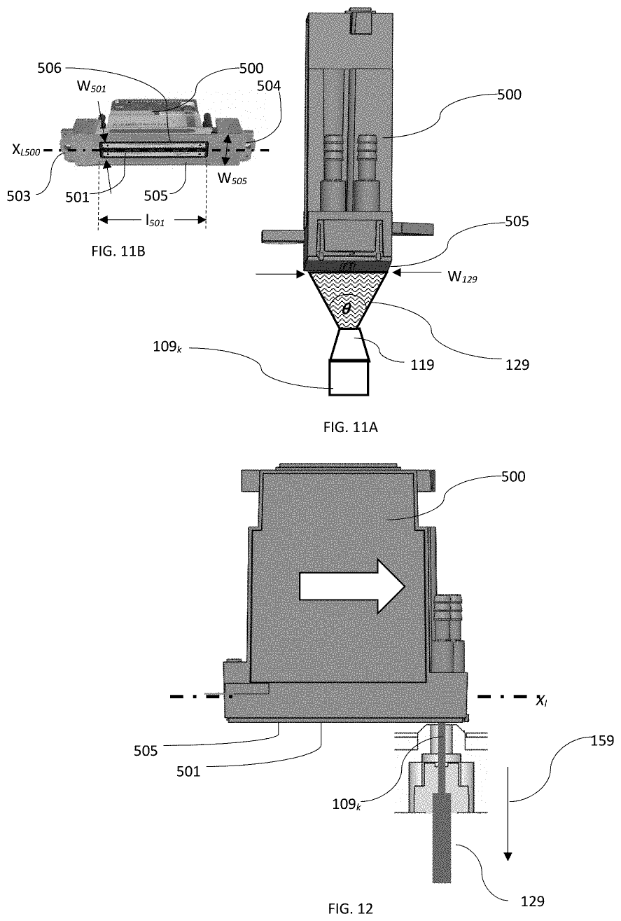

The methods for contactless cleaning of inkjet print heads can further comprise at a second predetermined event (for example, between about 6 hours and 10 hours, or upon noticing a precipitous decline in print quality, both which can be determined automatically), before the step of purging, advancing the plurality of print heads 500 along the longitudinal axis X₅₀₁ of the apertures grid in the nozzle plate 501 above the wash port 109k; and spraying guard plate 505 and nozzle plate 501 with cleaning liquid 129 (see e.g., FIGS. 5A, 5B, 11A, and 12), wherein elongated, or differently shaped (see e.g., FIG. 19B) washing port 109k protrudes apically from catch basin 105, the protrusion defining an elongated opening with axis X₁₀₉ transverse to longitudinal axis X₁₀₆ of elongated bath 106ᵢ and width W₁₀₉ that is equal to or larger than width W₅₀₁ of the print head's 500 nozzle plate 501, and wherein elongated washing port 109k further comprises a liquid ejection nozzle 119, sized and configured to eject a fan-shaped washing liquid 129 at an angle θ of between about 0° and about 180°. Washing port 109k is further coupled and in fluid communication with a vacuum source (see e.g., 159 FIGS. 2B and 12) configured to vacuum excess washing liquid, used to contain the washing port's spray of liquid washing fluid 129.

In certain embodiments, ejection of ink from nozzle plate 501 can employ dispensing means such as a piezoelectric element, which repeatedly applies and reduces pressure to eject ink, and can cause minute bubbles to form due to cavitation, or through turbulence once purged.

The ink and other components (e.g., build up residue, solid sediment and the like) suctioned off using the system described herein can be transported to a waste reclamation system (see e.g., FIGS. 16, 18), modified and returned to print head 500 ink reservoir. Similarly, washing liquid 129 sucked from suction duct 109k can be recycled into usable wash liquid. The recycling sub-system may comprise various components, for example filters, valves, adsorbing elements, manifolds, addition of various solvents and additives and the like. Generally, the term “recycling” refers to a sub-system used to reprocess the purged content such as, for example, ink of suction duct 108ₚ (see e.g., FIGS. 6, and 7) to a condition where it can be used effectively in the printing operation carried out. As an example, washing liquid 129 may be recycled in a separate system to the ink recycling system, see e.g., FIGS. 16 and 18.

The terms “first,” “second,” and the like, when used herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the channel(s) includes one or more channel). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

In addition, for the purposes of the present disclosure, directional or positional terms such as “top”, “apical”, “basal”, “proximal”, “distal”, “bottom”, “upper,” “lower,” “side,” “front,” “frontal,” “forward,” “rear,” “rearward,” “back,” “trailing,” “above,” “below,” “left,” “right,” “radial,” “vertical,” “upward,” “downward,” “outer,” “inner,” “exterior,” “interior,” “intermediate,” etc., are merely used for convenience in describing the various embodiments of the present disclosure.

The term “coupled”, including its various forms such as “operably coupled”, “coupling” or “coupleable”, refers to and comprises any direct or indirect, structural coupling, connection or attachment, or adaptation or capability for such a direct or indirect structural or operational coupling, connection or attachment, including integrally formed components and components which are coupled via or through another component or by the forming process (e.g., an electromagnetic field). Indirect coupling may involve coupling through an intermediary member or adhesive, or abutting and otherwise resting against, whether frictionally (e.g., against a wall) or by separate means without any physical connection.

The contactless cleaner used in the systems and methods for removing purged ink without mechanical or fluid contact described herein can further be in electric communication with at least one sensor (e.g., pressure sensor) and a processor, configured to maintain a predetermined pressure or a programmable pressure profile throughout the cleaning process and the recycling process and additionally or alternatively, diagnose problems in the system. For example, the system can comprise sensor array at various locations, with temperature and/or pressure and/or viscosity data feedback to the processor, which, in turn, will control the various valves, affecting gas flow fluid/spray pressure, and the like.

Other than proximity sensor 111, other sensors can be incorporated into the system, for example, image (visual) sensors (e.g., CMOS, CCD, for example to monitor ink color, drop shape/volume and nozzle status), microflow (or flow) sensors (e.g., EM based, Resonant feedback based, Pitot-based) viscosity sensors, timing sensors, conductivity sensors, or an array comprising one or more of the foregoing. The sensors, including the temperature sensors and/or humidity sensors can provide data to a processor comprising memory having thereon computer-readable media with a set of executable instruction enabling the processor, being in electronic communication with a driver or drivers, as well as the print heads, to automatically (in other words, without user intervention) change the position of the print heads, relative to the cleaning platform. The processor may also determine whether purging ink is recycled back to an ink reservoir in fluid communication with the print head or diverted to waste vessel.

The processor can further have a memory module with computer readable media stored thereon, comprising a set of instructions thereon configured to carry out the cleaning and/or recycling methods described herein, provide temperature/pressure controls, timing, movement, vacuum flow, spray pressure profile (t, P, fan angles) and form, continuous or pulsed spray and the like.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

All ranges disclosed herein are inclusive of the endpoints, and the endpoints are independently combinable with each other. Furthermore, the terms “first,” “second,” and the like, herein do not denote any order, quantity, or importance, but rather are used to denote one element from another.

Likewise, the term “about” means that amounts, ranges, sizes, formulations, parameters, and other quantities and characteristics are not and do not need be exact, but may be approximate and/or larger or smaller, as desired, reflecting tolerances, conversion factors, rounding off, measurement error and the like, and other factors known to those of skill in the art. In general, an amount, ranges, size, formulation, parameter or other quantity or characteristic is “about” or “approximate” whether or not expressly stated to be such and is intended to include the degree of error associated with measurement of the particular quantity based upon the equipment available at the time of filing the application. For example, “about” can include a range of +/−15% or 10%, or 5% of a given value.

While in the foregoing specification the systems and methods allowing CIP of print heads by selectably (in other words, without affecting the operation of other components in the system) alternating the position of a print head, or print heads, above various cleaning unit operations (e.g., purge, tickling, suction and washing), have been described in relation to certain preferred embodiments, and many details are set forth for purpose of illustration, it will be apparent to those skilled in the art that the disclosure of the systems and methods allowing CIP of print heads is susceptible to additional embodiments and that certain of the details described in this specification and as are more fully delineated in the following claims can be varied considerably without departing from the basic principles of this disclosure.

Accordingly and in an embodiment, provided herein is a contactless cleaning system for at least one and a plurality of inkjet print heads comprising: a support bracket; a platform having a proximal end and a distal end, an apical surface and a basal surface, a portion of the basal surface coupled to the support bracket; a catch basin defined in the apical surface of the platform; for each of the at least one and plurality of inkjet print heads, an elongated bath defining a longitudinal axis, the elongated bath having length that is equal to or longer than the length of a nozzle plate of each of the inkjet print head; for each of the at least one and plurality of inkjet print heads, a suction duct disposed distally to the elongated bath, the suction duct having a tip protruding apically from the catch basin with an elongated slit defining a longitudinal axis transverse to the longitudinal axis of the elongated bath; for each of the at least one and plurality of inkjet print heads, an elongated washing port in communication with a pressurized liquid source and a vacuum source; and a vacuum blade having a length spanning at least the area sought to be cleaned, the vacuum blade disposed distally to the washing port, being in communication with the vacuum source, wherein (i) each inkjet print head comprises: the nozzle plate with a grid of apertures along a longitudinal axis having a nozzle plate width transverse to the longitudinal axis of the nozzle plate; a guard plate with an elongated quadrilateral window sized and configured to expose the nozzle plate, the guard plate having guard plate width; and a dispensing means configured to dispense an ink, being in fluid communication with the ink reservoir, wherein the dispensing means is configured to dispense ink droplets through the nozzle plate, (ii) the apical surface of the platform further comprises a proximity sensor, (iii) each of the plurality of elongated baths corresponding to each of the print head(s), further comprises a drain in fluid or liquid communication with a receptacle, and (iv) is slanted toward the drain, (v) having a bath width that is equal to or wider than the width of the nozzle plate, (vi) wherein each suction duct is in fluid (liquid) communication with the vacuum source, through a dedicated vessel sized configured and adapted to capture and collect the ink adsorbed onto at least one of the nozzle plate and the guard plate of the print head, wherein (vii) the tip width of the elongated slit in the tip of the suction duct is equal to or wider than the width of the nozzle plate, wherein (viii) the elongated washing port protrudes apically from the catch basin, the protrusion defining an elongated opening with a major axis transverse to the longitudinal axis of the elongated bath and a width that is equal to or larger than the width of the at least one and the plurality of print head's nozzle plate, (ix) the aspect ratio between the washing port longitudinal axis and its transverse axis is between 1 and 10, (x) the elongated washing port further comprises a liquid ejection nozzle, sized and configured to eject a fan-shaped washing liquid at an angle of between about 0° and about 180°, (xi) the width of the washing liquid fan is equal to, or larger than the width of the nozzle plate of the print head, wherein the system (xii) comprising a first and a second print head, (xiii) a first and a second elongated bath, wherein the first and second elongated baths each comprises a drain in fluid communication with a first and a second receptacle respectively, (xiv) the first receptacle is also in fluid communication with a first suction duct, wherein (xv) the bracket is disposed in a dedicated cleaning zone (or cleaning station), (xvi) the washing liquid ejected from the washing port associated with the first print head is different than the washing liquid ejected from the second washing port, wherein (xvii) the shape of the ejected washing liquid in the washing port associated with the first print head is different than the shape of the ejected washing liquid in the washing port associated with the second print head, each selectable by the user or automatically based on inspection of the print head orifice plate, and wherein (xviii) the elongated washing port further comprises a liquid ejection nozzle, sized and configured to eject a fan-shaped washing liquid at an angle of between about 0° and about 120°.

In another embodiment, provided herein is a method for contactless cleaning of at least one and a plurality of inkjet print heads, implementable in a system comprising: a support bracket; a platform having a proximal end and a distal end, an apical surface and a basal surface, a portion of the basal surface coupled to the support bracket; a catch basin defined in the apical surface of the platform; for each of the plurality of inkjet print heads, an elongated bath defining a longitudinal axis, the elongated bath having length that is equal to or longer than the length of a nozzle plate of each of the inkjet print head; for each of the plurality of inkjet print heads, a suction duct disposed distally to the elongated bath, the suction duct having a tip protruding apically to the catch basin with an elongated slit defining a longitudinal axis transverse to the longitudinal axis of the elongated bath; for each of the plurality of inkjet print heads, an elongated washing port in communication with a pressurized liquid source and a vacuum source; and a vacuum blade having a length spanning the area sought to be cleaned, the vacuum blade disposed distally to the washing port, being in communication with the vacuum source, wherein each of the at least one and the plurality of inkjet print heads comprises: the nozzle plate with a grid of apertures along a longitudinal axis having a nozzle plate width transverse to the longitudinal axis of the nozzle plate; a guard plate with an elongated quadrilateral window sized and configured to expose the nozzle plate, the guard plate having guard plate width; and a dispensing means configured to dispense an ink, being in fluid communication with the ink reservoir, wherein the dispensing means is configured to dispense ink droplets through the nozzle plate the method comprising: at a first predetermined event, actuating the vacuum source; advancing the at least one and plurality of print head along the longitudinal axis of the apertures grid in the nozzle plate in a proximal distance above the vacuum blade thereby removing excess ink from the nozzle plates and the area between and around the at least one and the plurality of print head s; following clearing of a distal end of the guard plate, purging the at least one and the plurality of print heads into at least one of the elongated bath and catch basin; and advancing the at least one and the plurality of plurality of print head along the longitudinal axis of the apertures grid in the nozzle plate in distal direction above the suction duct, thereby removing purged ink and cleaning the plurality of nozzle plates and guard plates, (xix) further comprising: at a second predetermined event, before the step of purging, advancing the at least one and the plurality of print heads along the longitudinal axis of the apertures grid in the nozzle plate above the wash port; and spraying the guard plate and nozzle plate with a cleaning liquid, wherein the elongated washing port protrudes apically from the catch basin, the protrusion defining an elongated opening with an axis transverse to the longitudinal axis of the elongated bath and a width that is equal to or larger than the width of the print head's nozzle plate, and wherein the elongated washing port further comprises a liquid ejection nozzle, sized and configured to eject a fan-shaped washing liquid at an angle of between about 0° and about 180°, (xx) wherein the aspect ratio between the washing port longitudinal axis and its transverse axis is between 1 and 10, the system further comprising (xxi) at least one and a plurality of elongated baths, wherein the at least one and the plurality of elongated baths each comprises a drain in fluid communication with a receptacle respectively, (xxii) each receptacle is in fluid communication with a dedicated recycling system, wherein (xxiii) the elongated washing port further comprises a liquid ejection nozzle, sized and configured to eject a fan-shaped washing liquid at an angle of between about 0° and about 180°, (xxiv) the washing liquid ejected from the washing port is not the same for each print head, wherein (xxv) the shape of the ejected washing liquid in the washing port associated with the first print head is different than the shape of the ejected washing liquid in the washing port associated with the second print head, each selectable by the user or automatically based on inspection of the print head orifice plate, and wherein (xxvi) the elongated washing port further comprises a liquid ejection nozzle, sized and configured to eject a fan-shaped washing liquid at an angle of between about 0° and about 120°.

1. A contactless cleaning system for at least one and a plurality of inkjet print heads comprising:
a. a support bracket;
b. a platform having a proximal end and a distal end, an apical surface and a basal surface, a portion of the basal surface coupled to the support bracket;
c. a catch basin defined in the apical surface of the platform;
d. for each of the at least one and plurality of inkjet print heads, an elongated bath defining a longitudinal axis, the elongated bath having length that is equal to or longer than the length of a nozzle plate of each of the inkjet print head;
e. for each of the at least one and plurality of inkjet print heads, a suction duct disposed distally to the elongated bath, the suction duct having a tip protruding apically from the catch basin with an elongated slit defining a longitudinal axis transverse to the longitudinal axis of the elongated bath;
f. for each of the at least one and plurality of inkjet print heads, an elongated washing port in communication with a pressurized liquid source and a vacuum source; and
g. a vacuum blade having a length spanning at least the area sought to be cleaned, the vacuum blade disposed distally to the washing port, being in communication with the vacuum source.

2. The system of claim 1, wherein each inkjet print head comprises:
a. the nozzle plate with a grid of apertures along a longitudinal axis having a nozzle plate width transverse to the longitudinal axis of the nozzle plate;
b. a guard plate with an elongated quadrilateral window sized and configured to expose the nozzle plate, the guard plate having guard plate width; and
c. a dispensing means configured to dispense an ink, being in fluid communication with the ink reservoir, wherein the dispensing means is configured to dispense ink droplets through the nozzle plate.

3. The system of claim 2, wherein the apical surface of the platform further comprises a proximity sensor.

4. The system of claim 2, wherein each of the elongated baths further comprises a drain in fluid communication with a receptacle.

5. The system of claim 4, wherein each elongated bath is slanted toward the drain.

6. The system of claim 5, wherein each elongated bath has a bath width that is equal to or wider than the width of the nozzle plate.

7. The system of claim 2, wherein each suction duct is in fluid communication with the vacuum source, through a dedicated vessel configured to capture and collect the ink adsorbed onto at least one of the nozzle plate and the guard plate of the print head.

8. The system of claim 7, wherein the tip width of the elongated slit in the tip of the suction duct is equal to or wider than the width of the nozzle plate.

9. The system of claim 2, wherein the elongated washing port protrudes apically from the catch basin, the protrusion defining an elongated opening with an axis transverse to the longitudinal axis of the elongated bath and a width that is equal to or larger than the width of the at least one and the plurality of print head's nozzle plate.

10. The system of claim 9, wherein the elongated washing port further comprises a liquid ejection nozzle, sized and configured to eject a fan-shaped washing liquid at an angle of between about 0° and about 180°.

11. The system of claim 10, wherein the width of the washing liquid fan is equal to, or larger than the width of the nozzle plate of the print head.

12. The system of claim 10, comprising a first and a second print head.

13. The system of claim 12, comprising a first and a second elongated bath, wherein the first and second elongated baths each comprises a drain in fluid communication with a first and a second receptacle respectively.

14. The system of claim 13, wherein the first receptacle is also in fluid communication with a first suction duct.

15. The system of claim 1, wherein the bracket is disposed in a dedicated cleaning zone.

16. The system of claim 9, wherein the aspect ratio between the washing port longitudinal axis and its transverse axis is between 1 and 10.

17. The system of claim 12, wherein the washing liquid ejected from the washing port associated with the first print head is different than the washing liquid ejected from the second washing port.

18. The system of claim 17, wherein the shape of the ejected washing liquid in the washing port associated with the first print head is different than the shape of the ejected washing liquid in the washing port associated with the second print head.

19. The system of claim 10, wherein the elongated washing port further comprises a liquid ejection nozzle, sized and configured to eject a fan-shaped washing liquid at an angle of between about 0° and about 120°.

20. A method for contactless cleaning of at least one and a plurality of inkjet print heads, implementable in a system comprising: a support bracket; a platform having a proximal end and a distal end, an apical surface and a basal surface, a portion of the basal surface coupled to the support bracket; a catch basin defined in the apical surface of the platform; for each of the plurality of inkjet print heads, an elongated bath defining a longitudinal axis, the elongated bath having length that is equal to or longer than the length of a nozzle plate of each of the inkjet print head; for each of the plurality of inkjet print heads, a suction duct disposed distally to the elongated bath, the suction duct having a tip protruding apically to the catch basin with an elongated slit defining a longitudinal axis transverse to the longitudinal axis of the elongated bath; for each of the plurality of inkjet print heads, an elongated washing port in communication with a pressurized liquid source and a vacuum source; and a vacuum blade having a length spanning the area sought to be cleaned, the vacuum blade disposed distally to the washing port, being in communication with the vacuum source, wherein each of the at least one and the plurality of inkjet print heads comprises: the nozzle plate with a grid of apertures along a longitudinal axis having a nozzle plate width transverse to the longitudinal axis of the nozzle plate; a guard plate with an elongated quadrilateral window sized and configured to expose the nozzle plate, the guard plate having guard plate width; and a dispensing means configured to dispense an ink, being in fluid communication with the ink reservoir, wherein the dispensing means is configured to dispense ink droplets through the nozzle plate the method comprising:
a. at a first predetermined event, actuating the vacuum source;
b. advancing the at least one and plurality of print head along the longitudinal axis of the apertures grid in the nozzle plate in a proximal distance above the vacuum blade thereby removing excess ink from the nozzle plates and the area between and around the at least one and the plurality of print head s;
c. following clearing of a distal end of the guard plate, purging the at least one and the plurality of print heads into at least one of the elongated bath and catch basin; and
d. advancing the at least one and the plurality of plurality of print head along the longitudinal axis of the apertures grid in the nozzle plate in distal direction above the suction duct, thereby removing purged ink and cleaning the plurality of nozzle plates and guard plates.

21. The method of claim 20, further comprising:
a. at a second predetermined event, before the step of purging, advancing the at least one and the plurality of print heads along the longitudinal axis of the apertures grid in the nozzle plate above the wash port; and
b. spraying the guard plate and nozzle plate with a cleaning liquid, wherein the elongated washing port protrudes apically from the catch basin, the protrusion defining an elongated opening with an axis transverse to the longitudinal axis of the elongated bath and a width that is equal to or larger than the width of the print head's nozzle plate, and wherein the elongated washing port further comprises a liquid ejection nozzle, sized and configured to eject a fan-shaped washing liquid at an angle of between about 0° and about 180°.

22. The method of claim 20, wherein the aspect ratio between the washing port longitudinal axis and its transverse axis is between 1 and 10.

23. The method of claim 20, wherein the system further comprising at least one and a plurality of elongated baths, wherein the at least one and the plurality of elongated baths each comprises a drain in fluid communication with a receptacle respectively.

24. The method of claim 21, wherein each receptacle is in fluid communication with a dedicated recycling system.

25. The method of claim 20, wherein the elongated washing port further comprises a liquid ejection nozzle, sized and configured to eject a fan-shaped washing liquid at an angle of between about 0° and about 180°.

26. The method of claim 25, wherein the washing liquid ejected from the washing port is not the same for each print head.

27. The method of claim 25 or 26, wherein the shape of the ejected washing liquid is not the same for each print head.

28. The method of claim 25, wherein the elongated washing port further comprises a liquid ejection nozzle, sized and configured to eject a fan-shaped washing liquid at an angle of between about 0° and about 120°.
